(19) United States
(12) Patent Application Publication
(10) Pub. No.: US 2024/0289493 A1
(43) Pub. Date: Aug. 29, 2024

(54) SECURE COMPUTATION SYSTEM, SECURE COMPUTATION SERVER APPARATUS, SECURE COMPUTATION METHOD, AND SECURE COMPUTATION PROGRAM

(71) Applicant: NEC Corporation, Minato-ku, Tokyo (JP)

(72) Inventor: Hikaru TSUCHIDA, Tokyo (JP)

(73) Assignee: NEC Corporation, Minato-ku, Tokyo (JP)

(21) Appl. No.: 18/281,857

(22) PCT Filed: Mar. 18, 2021
(86) PCT No.: PCT/JP2021/011042

§ 371 Date: Sep. 13, 2023

(51) Int. Cl. G06F 21/64; G09C 1/00

(52) U.S. Cl. CPC G06F 21/64; G09C 1/00

(57) ABSTRACT

An individual secure computation server apparatus in a secure computation system computes, by using a cyclic permutation shared by secure computation server apparatuses except one of the secure computation server apparatuses, a value of a cyclic permutation for the one secure computation server apparatus, performs a fraud detection by performing an equality check on values of cyclic permutations computed by the other secure computation server apparatuses, constitutes a random cyclic permutation by synthesizing the cyclic permutations, applies the random cyclic permutation to the share in the sequence, computes a share which indicates an index and to which the random cyclic permutation has been applied by adding a share having a shift amount of the cyclic permutation to the share which indicates the index, reconstructs the share which indicates the index and to which the random cyclic permutation has been applied, and selects a share corresponding to the reconstructed index.

### TECHNICAL FIELD

The present invention relates to a secure computation system, a secure computation server apparatus, a secure computation method, and a secure computation program.

### BACKGROUND ART

In recent years, research and development have been actively conducted on a technique referred to as secure computation. Secure computation is one of the techniques for executing predetermined processing while keeping its computation processes and the results thereof secret to third parties. One typical technique used for secure computation is a multiparty computation technique. In this multiparty computation technique, data that needs to be kept secret is dispersedly distributed to a plurality of servers (secure computation server apparatuses), and each server performs various operations on the data distributed thereto while keeping the data secret. The data dispersedly distributed to the individual secure computation server apparatuses is called “shares”. Hereinafter, unless otherwise stated, the term “secure computation” used herein signifies the multiparty computation technique.

One of the processes performed in the secure computation is sequence reference. Sequence reference is a process for referring to elements arranged and stored in a sequence. In this sequence reference in the secure computation, when the elements in a sequence are referred to, indexes allocated to these elements are used, and there is a demand for concealing these indexes, too. That is, there is a demand for enabling reading and writing of desired elements in a sequence while concealing which elements in the sequence are being accessed.

For example, credit decisions, etc., are made by using a plurality of items of information, and there is a situation where a user wishes to conceal not only the contents of items of information but also the items of information used to make a credit decision. In response to such a demand, there is an application in which the secure computation uses a sequence reference that conceals indexes. In addition, by analyzing a pattern of access to the elements in a sequence, information could be leaked. Thus, accessing the elements in a sequence while concealing the access pattern is advantageous in term of security.

### CITATION LIST

### Non-Patent Literature

NPL 1: Marina Blanton, Ahreum Kang, and Chen Yuan. “Improved building blocks for secure multi-party computation based on secret sharing with honest majority.” International Conference on Applied Cryptography and Network Security. Springer, Chain, 2020

### SUMMARY

### Technical Problem

The disclosure of the above citation list is incorporated herein in its entirety by reference thereto. The following analysis has been made by the present inventors.

In the secure computation using the multiparty computation technique, data that needs to be kept secret is dispersedly distributed to a plurality of servers, and these servers perform their processing. Thus, to improve the efficiency of the processing, the communication cost needs to be reduced. This communication cost can be divided into the communication amount representing the amount of communication target data and the communication round number representing the number of communications performed when the maximum parallelization is performed.

Regarding this relationship between the communication amount and the round number, depending on the environment, a different one of the communication amount and the communication round number needs to be prioritized over the other. For example, in an environment in which the communication delay is large, such as in a WAN (Wide Area Network) environment, a fewer number of communications is more advantageous. Thus, it is preferable that the secure computation be performed with a fewer number of communication rounds, more preferably, with a constant number of rounds.

Of course, the security of the secure computation also needs to be ensured. There are various levels in terms of the security of the secure computation, and “semi-honest secure” is known as a typical security level. An attack for obtaining information about the input and values acquired in the computation processes while conforming to the protocol is referred to as a semi-honest attack. If the security against this semi-honest attack is ensured, this secure computation is considered as being semi-honest secure.

However, a participant who attempts an attack to falsify a computation result by deviating from the protocol could slip into the secure computation using the multiparty computation technique. Detecting the falsification of a value by such a dishonest participant is referred to as fraud detection. Although NPL 1 discusses a sequence reference protocol that achieves the communication cost with a constant number of rounds, this technique is semi-honest secure. Thus, in this sense, the fraud detection cannot be performed. Therefore, there is a demand for a sequence reference protocol that achieves the communication cost with a constant number of rounds and that has an improved security enabling the fraud detection.

In view of the above-described problem, an object of the present invention is to provide a secure computation system, a secure computation server apparatus, a secure computation method, and a secure computation program that contribute to both reducing the communication cost and improving the security while using a sequence reference protocol.

### Solution to Problem

According to a first aspect of the present invention, there is provided a secure computation system, including at least four secure computation server apparatuses connected to each other via a network, receiving a share which indicates index, and referring to a share of an element in a sequence corresponding to the indexes from the shares in the sequence, an individual one of the secure computation server apparatuses including: a local cyclic permutation part that computes, by using a cyclic permutation shared by (other) secure computation server apparatuses except one of the at least four secure computation server apparatuses, a value of a cyclic permutation for the one secure computation server apparatus; a comparison and verification part that performs a fraud detection by performing an equality check on a plurality of values of cyclic permutations computed by the secure computation server apparatuses except oneself of the at least four secure computation server apparatuses; a permutation synthesis part that constitutes a random cyclic permutation that is traceable by none of the at least four secure computation server apparatuses by synthesizing the cyclic permutations constituted by the local cyclic permutation parts of the secure computation server apparatuses; a sequence shuffle part that applies the random cyclic permutation to the shares in the sequence; an index computation part that computes a share which indicates an index and to which the random cyclic permutation has been applied by adding a share having a shift amount of the cyclic permutation constituted by the local cyclic permutation parts to the received share which indicates the index; and a sequence selection part that reconstructs the share which indicates the index and to which the random cyclic permutation has been applied and that selects a share corresponding to the reconstructed index from the shares in the sequence to which the random cyclic permutation has been applied.

According to a second aspect of the present invention, there is provided a secure computation server apparatus, which is one of at least four secure computation server apparatuses connected to each other via a network, each of the secure computation server apparatuses receiving a share which indicates an index, and referring to a share of an element in a sequence corresponding to the index from the shares in the sequence, the secure computation server apparatus including: a local cyclic permutation part that computes, by using a cyclic permutation shared by (other) secure computation server apparatuses except one of the at least four secure computation server apparatuses, a value of a cyclic permutation for the one secure computation server apparatus; a comparison and verification part that performs a fraud detection by performing an equality check on a plurality of values of cyclic permutations computed by the secure computation server apparatuses except oneself of the at least four secure computation server apparatuses; a permutation synthesis part that constitutes a random cyclic permutation that is traceable by none of the at least four secure computation server apparatuses by synthesizing the cyclic permutations constituted by the local cyclic permutation parts of the secure computation server apparatuses; a sequence shuffle part that applies the random cyclic permutation to the shares in the sequence; an index computation part that computes a share which indicates an indexes and to which the random cyclic permutation has been applied by adding a share having a shift amount of the cyclic permutation constituted by the local cyclic permutation parts to the received shares which indicates the index; and a sequence selection part that reconstructs the share which indicates the index and to which the random cyclic permutation has been applied and that selects a share corresponding to the reconstructed index from the shares in the sequence to which the random cyclic permutation has been applied.

According to a third aspect of the present invention, there is provided a secure computation method, using at least four secure computation server apparatuses connected to each other via a network, receiving a share which indicates an index, and referring to a share of an element in a sequence corresponding to the index from the shares in the sequence, the secure computation method including: a local cyclic permutation step of computing, by using a cyclic permutation shared by (other) secure computation server apparatuses except one of the at least four secure computation server apparatuses, a value of a cyclic permutation for the one secure computation server apparatus; a comparison and verification step of performing a fraud detection by performing an equality check on a plurality of values of cyclic permutations computed by the secure computation server apparatuses except oneself of the at least four secure computation server apparatuses; a permutation synthesis step of constituting a random cyclic permutation that is traceable by none of the at least four secure computation server apparatuses by synthesizing the cyclic permutations constituted in the local cyclic permutation step; a sequence shuffle step of applying the random cyclic permutation to the shares in the sequence; an index computation step of computing a share which indicates index and to which the random cyclic permutation has been applied by adding a share having a shift amount of the cyclic permutation constituted by the local cyclic permutation step to the received share which indicates the index; and a sequence selection step of reconstructing the share which indicates the index and to which the random cyclic permutation has been applied and selecting a share corresponding to the reconstructed index from the shares in the sequence to which the random cyclic permutation has been applied.

According to a fourth aspect of the present invention, there is provided a secure computation program, causing each of at least four secure computation server apparatuses connected to each other via a network, each of the secure computation server apparatuses receiving a share which indicates index, and referring to a share of an element in a sequence corresponding to the index from the shares in the sequence, to perform: local cyclic permutation processing for computing, by using a cyclic permutation shared by (other) secure computation server apparatuses except one of the at least four secure computation server apparatuses, a value of a cyclic permutation for the one secure computation server apparatus; comparison and verification processing for performing a fraud detection by performing an equality check on a plurality of values of cyclic permutations computed by the secure computation server apparatuses except oneself of the at least four secure computation server apparatuses; permutation synthesis processing for constituting a random cyclic permutation that is traceable by none of the at least four secure computation server apparatuses by synthesizing the cyclic permutations constituted by the local cyclic permutation processing; sequence shuffle processing for applying the random cyclic permutation to the shares in the sequence; index computation processing for computing a share which indicates an index and to which the random cyclic permutation has been applied by adding a share having a shift amount of the cyclic permutation constituted by the local cyclic permutation processing to the received share which indicates the index; and sequence selection processing for reconstructing the share which indicates the index and to which the random cyclic permutation has been applied and selecting a share corresponding to the reconstructed indexes from the shares in the sequence to which the random cyclic permutation has been applied. The program can be recorded in a computer-readable storage medium. The storage medium may be a non-transient storage medium such as a semiconductor memory, a hard disk, a magnetic recording medium, or an optical recording medium. The present invention can be embodied as a computer program product.

### Advantageous Effects of Invention

According to the individual aspects of the present invention, it is possible to provide a secure computation system, a secure computation server apparatus, a secure computation method, and a secure computation program that contribute to both reducing the communication cost and improving the security while using a sequence reference protocol.

### BRIEF DESCRIPTION OF DRAWINGS

FIG. 1 is a block diagram illustrating a functional configuration example of a secure computation system according to a first example embodiment.

FIG. 2 is a block diagram illustrating a functional configuration example of a secure computation server apparatus according to the first example embodiment.

FIG. 3 is a drawing illustrating a principle of computing a share which indicates index after a random cyclic permutation has been applied.

FIG. 4 is a flowchart illustrating an outline of a procedure of a secure computation method according to the first example embodiment.

FIG. 5 is a block diagram illustrating a functional configuration example of a secure computation system according to a second example embodiment.

FIG. 6 is a flowchart illustrating an outline of a procedure of a secure computation method according to the second example embodiment.

FIG. 7 is a block diagram illustrating a functional configuration example of a secure computation system according to a third example embodiment.

FIG. 8 is a flowchart illustrating an outline of a procedure of a secure computation method according to the third example embodiment.

FIG. 9 is a diagram illustrating a hardware configuration example of a secure computation server apparatus.

### EXAMPLE EMBODIMENTS

Hereinafter, example embodiments of the present invention will be described with reference to the accompanying drawings. However, the present invention is not limited to the following example embodiments. In addition, in the drawings, the same or equivalent elements are denoted by the same reference characters, as necessary. In addition, the drawings are schematic drawings, and therefore, it should be noted that the sizes, ratios, etc. of the individual elements may differ from their actual sizes, ratios, etc. An element in a drawing may have a portion whose size or ratio differs from that of the portion of the element in a different drawing.

### First Example Embodiment

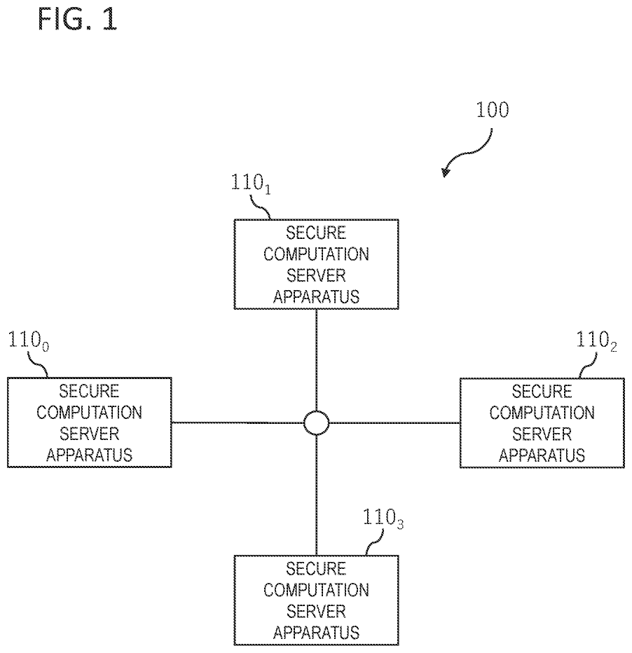

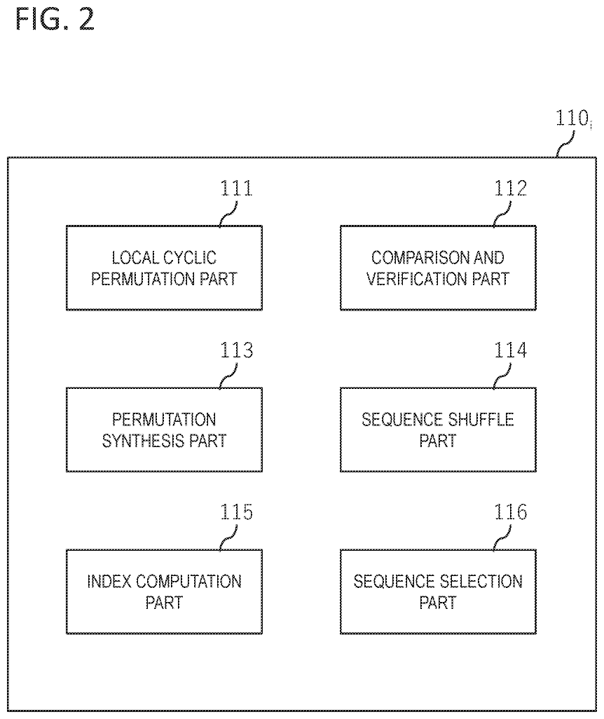

Hereinafter, a secure computation system and secure computation server apparatuses according to a first example embodiment will be described with reference to FIGS. 1 and 2. The first example embodiment is an example embodiment for describing only a basic concept of the present invention.

FIG. 1 is a block diagram illustrating a functional configuration example of the secure computation system according to the first example embodiment. As illustrated in FIG. 1, a secure computation system 100 according to the first example embodiment includes at least zeroth to third secure computation server apparatuses 110ᵢ (i=0, 1, 2, 3). These zeroth to third secure computation server apparatuses 110ᵢ (i=0, 1, 2, 3) are connected to each other via a network such that these apparatuses can communicate with each other. The circle in the middle in FIG. 1 represents a network.

In the secure computation system 100 including the zeroth to third secure computation server apparatuses 110ᵢ (i=0, 1, 2, 3), it is possible to compute target shares from a value inputted to any one of the zeroth to third secure computation server apparatuses 110ᵢ (i=0, 1, 2, 3) while keeping the input value and the values acquired in the computation processes secret, and it is possible to dispersedly store the computation results in the zeroth to (N−1)th secure computation server apparatuses 110ᵢ (i=0, 1, 2, 3).

In addition, in the secure computation system 100 including the zeroth to third secure computation server apparatuses 110ᵢ (i=0, 1, 2, 3), it is possible to compute target shares from the shares dispersedly stored in the zeroth to third secure computation server apparatuses 110ᵢ (i=0, 1, 2, 3) while keeping the values in the computation processes secret, and it is possible to dispersedly store the computation results in the zeroth to (N−1)th secure computation server apparatuses 110ᵢ (i=0, 1, 2, 3).

The shares of the computation results may be reconstructed by causing the zeroth to third secure computation server apparatuses 110ᵢ (i=0, 1, 2, 3) to exchange their shares with each other. Alternatively, the shares may be decoded by transmitting the shares to an external apparatus other than the zeroth to (N−1)th secure computation server apparatuses 110ᵢ (i=0, 1, 2, 3).

The secure computation system 100 according to the first example embodiment illustrated in FIG. 1 is a secure computation system that receives a share which indicates index, and that refers to a share of an element in a sequence corresponding to the index from the shares in the sequence. Each of the zeroth to third secure computation server apparatuses 110ᵢ (i=0, 1, 2, 3) is operated by an independent participant Pᵢ (i=0, 1, 2, 3). In addition, in the secure computation system 100 including the zeroth to third secure computation server apparatuses 110ᵢ (i=0, 1, 2, 3), even if part of the zeroth to third secure computation server apparatuses 110ᵢ (i=0, 1, 2, 3) is operated by a dishonest participant, a fraud can be detected.

To achieve this, as illustrated in FIG. 2, each of the zeroth to third secure computation server apparatuses 110ᵢ (i=0, 1, 2, 3) includes a local cyclic permutation part 111, a comparison and verification part 112, a permutation synthesis part 113, a sequence shuffle part 114, an index computation part 115, and a sequence selection part 116. FIG. 2 is a block diagram illustrating a functional configuration example of a secure computation server apparatus according to the first example embodiment.

The local cyclic permutation part 111 computes, by using a cyclic permutation shared by three of the zeroth to third secure computation server apparatuses 110ᵢ (i=0, 1, 2, 3), a value of a cyclic permutation for the other secure computation server apparatus.

The comparison and verification part 112 that performs a fraud detection by performing an equality check on a plurality of values of cyclic permutations computed by the zeroth to third secure computation server apparatuses 110ᵢ (i=0, 1, 2, 3) except its host secure computation server apparatus 110ᵢ. For example, when a cyclic permutation for the zeroth secure computation server apparatus 110₀ is computed by using a cyclic permutation shared by the first to third secure computation server apparatuses 110ᵢ (i=1, 2, 3), the zeroth secure computation server apparatus 110₀ receives values obtained after the application of the cyclic permutation, the values being supposed to be the same value, from the first to third secure computation server apparatuses 110ᵢ (i=1, 2, 3). However, if one of the first to third secure computation server apparatuses 110ᵢ (i=1, 2, 3) is operated by a dishonest participant and if a value has been falsified, the values received by the zeroth secure computation server apparatus 110₀ do not match. The comparison and verification part 112 performs a fraud detection by performing an equality check as described above.

The permutation synthesis part 113 constitutes a random cyclic permutation that is traceable by none of the zeroth to third secure computation server apparatuses 110ᵢ (i=0, 1, 2, 3) by synthesizing the cyclic permutations constituted by the local cyclic permutation parts 111 of the zeroth to third secure computation server apparatuses 110ᵢ (i=0, 1, 2, 3). The cyclic permutation constituted by one local cyclic permutation part 111 is a cyclic permutation that is not traceable by its host one of the zeroth to third secure computation server apparatuses 110ᵢ (i=0, 1, 2, 3). Assuming that the cyclic permutation that is not traceable by an i-th secure computation server apparatus 110ᵢ is σᵢ, σ=σ₀ σ₁ σ₂ σ₃ is a random cyclic permutation that is traceable by none of the zeroth to third secure computation server apparatuses 110ᵢ (i=0, 1, 2, 3).

The sequence shuffle part 114 applies the random cyclic permutation to the shares in the reference target sequence. Since the random cyclic permutation is not traceable by none of the zeroth to third secure computation server apparatuses 110ᵢ (i=0, 1, 2, 3), the sequence after the application of the random cyclic permutation also becomes unclear to the zeroth to third secure computation server apparatuses 110ᵢ (i=0, 1, 2, 3). In other words, information about the indexes is lost from the shares in the sequence.

The index computation part 115 computes a share which indicates index and to which the random cyclic permutation has been applied by adding a share having shift amounts of the cyclic permutation constituted by the local cyclic permutation parts 111 to the received share which indicates the index. As described above, by applying the random cyclic permutation to the shares in the reference target sequence, information about the indexes is lost from the shares in the sequence. Thus, by adding a share having shift amounts of the cyclic permutation to the received share which indicates the index, the index computation part 115 computes a share which indicates index and to which the random cyclic permutation has been applied. The computation principle will be described in detail below.

The sequence selection part 116 reconstructs the share which indicates the index and to which the random cyclic permutation has been applied and selects a share corresponding to the reconstructed index from the shares in the sequence to which the random cyclic permutation has been applied.

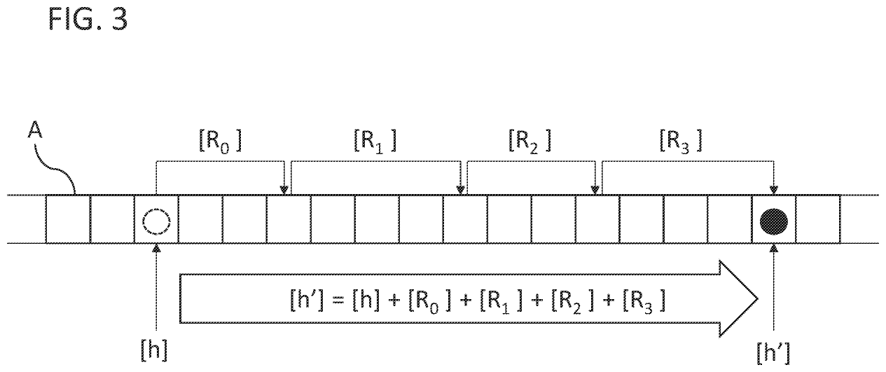

FIG. 3 is a drawing illustrating a principle of computing a share which indicates index after a random cyclic permutation has been applied. As illustrated in FIG. 3, in the sequence reference, it is possible to refer to desired data from an arranged and stored dataset. Concretely, an arranged and stored dataset is given indexes, and by specifying an index, it is possible to refer to desired data.

Herein, in the sequence reference in a secure computation, the indexes are also kept secret. That is, the participants in the secure computation cannot directly determine which data they need to access. In the above-described secure computation system 100, the sequence reference is performed in accordance with the following mechanism.

First, a random cyclic permutation constructed as described above is applied to a target sequence. That is, assuming that the cyclic permutation untraceable by the i-th secure computation server apparatus 110ᵢ is σᵢ, the random cyclic permutation a obtained by synthesizing these cyclic permutations (σ=σ₁ σ₂ σ₃) is applied to a target sequence. Herein, assuming that the shift amount of the cyclic permutation σᵢ is Rᵢ, the shift amount of the random cyclic permutation a is expressed by R₀+R₁+R₂+R₃. Thus, if the reference target index is h, the index that needs to be referred to after the random cyclic permutation has been applied is expressed by h′=h+R₀+R₁+R₂+R₃. These computations are performed as secure computations while being kept secret.

Herein, it should be noted that the i-th secure computation server apparatus 110ᵢ cannot trace the cyclic permutation σᵢ. That is, the i-th secure computation server apparatus 110ᵢ cannot determine the shift amount Rᵢ of the cyclic permutation σᵢ. Consequently, the i-th secure computation server apparatus 110ᵢ cannot compute the original index h from the reference target index h′ after the random cyclic permutation has been applied, by using the computation expression h′=h+R₀+R₁+R₂+R₃.

As described above, in the above-described secure computation system 100, it is possible to compute the reference target index h′ after the random cyclic permutation has been applied while concealing the original index h.

### (Secure Computation Method)

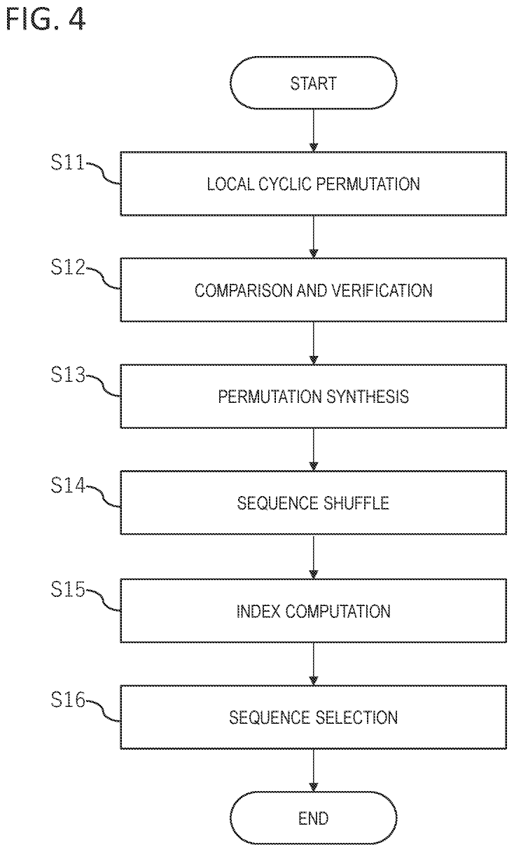

FIG. 4 is a flowchart illustrating an outline of a procedure of a secure computation method according to the first example embodiment. The procedure of the secure computation method illustrated in FIG. 4 is only a typical example of the procedure of the secure computation and will be described to facilitate the description. In practice, the secure computation method can be modified, such as by changing the order of some of the steps or repeating some of the steps.

As illustrated in FIG. 4, the secure computation method according to the first example embodiment includes a local cyclic permutation step (step S11), a comparison and verification step (step S12), a permutation synthesis step (step S13), a sequence shuffle step (step S14), an index computation step (step S15), and a sequence selection step (step S16).

The local cyclic permutation step (step S11) includes computing, by using a cyclic permutation shared by three of the zeroth to third secure computation server apparatuses 110ᵢ (i=0, 1, 2, 3), a value of a cyclic permutation for the other secure computation server apparatus.

The comparison and verification step (step S12) includes performing a fraud detection by performing an equality check on a plurality of values of cyclic permutations computed by the zeroth to third secure computation server apparatuses 110ᵢ (i=0, 1, 2, 3) except one (oneself) of the secure computation server apparatuses.

The permutation synthesis step (step S13) includes constituting a random cyclic permutation that is traceable by none of the zeroth to third secure computation server apparatuses 110ᵢ (i=0, 1, 2, 3) by synthesizing the cyclic permutations of the zeroth to third secure computation server apparatuses 110ᵢ (i=0, 1, 2, 3) in the local cyclic permutation step (step S11).

The sequence shuffle step (step S14) includes applying the random cyclic permutation to the shares in the reference target sequence.

The index computation step (step S15) includes computing a share which indicates index and to which the random cyclic permutation has been applied by adding a share having a shift amount of the cyclic permutation constituted by the local cyclic permutation parts to the received share which indicates the index. This computation principle has already been described above.

The sequence selection step (step S16) includes reconstructing the share which indicates the index and to which the random cyclic permutation has been applied and selecting a share corresponding to the reconstructed index from the shares in the sequence to which the random cyclic permutation has been applied.

As seen from the above description, the local cyclic permutation step (step S11), the comparison and verification step (step S12), the permutation synthesis step (step S13), and the sequence shuffle step (step S14) do not need input of the shares indicating the indexes. Thus, in a situation such as in Private Information Retrieval, it is possible to use a so-called offline-online paradigm in which the local cyclic permutation step (step S11), the comparison and verification step (step S12), the permutation synthesis step (step S13), and the sequence shuffle step (step S14) are performed in advance without waiting for input of the shares indicating the indexes.

As described above, the secure computation system and the secure computation method according to the first example embodiment enable a fraud detection while using a sequence reference protocol that achieves the communication cost even with a constant number of rounds. That is, the secure computation system and the secure computation method according to the first example embodiment contribute to both reducing the communication cost and improving the security while using a sequence reference protocol.

The above-described first example embodiment is an example embodiment for describing only a basic concept of the present invention. Hereinafter, in the description of a second example embodiment and a third example embodiment, the above-described concept will be applied to a specific secret sharing scheme.

### Second Example Embodiment

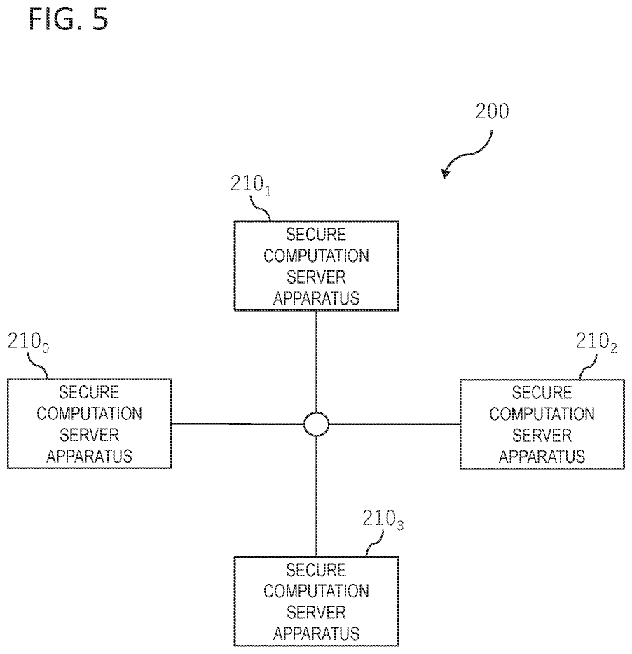

Next, a secure computation system according to a second example embodiment will be described with reference to FIG. 5.

FIG. 5 is a block diagram illustrating a functional configuration example of the secure computation system according to the second example embodiment. As illustrated in FIG. 5, a secure computation system 200 according to the second example embodiment includes zeroth to third secure computation server apparatuses 210ᵢ (i=0, 1, 2, 3). The zeroth to third secure computation server apparatuses 210ᵢ (i=0, 1, 2, 3) are connected to each other via a network such that these apparatuses can communicate with each other.

The secure computation system 200 according to the second example embodiment illustrated in FIG. 5 is a secure computation system that receives a share which indicates index, and that refers to a share of an element in a sequence corresponding to the index from the shares in the sequence. Each of the zeroth to third secure computation server apparatuses 210ᵢ (i=0, 1, 2, 3) is operated by an independent participant Pᵢ (i=0, 1, 2, 3). In addition, in the secure computation system 200 including the zeroth to third secure computation server apparatuses 210ᵢ (i=0, 1, 2, 3), even if part of the zeroth to third secure computation server apparatuses 210ᵢ (i=0, 1, 2, 3) is operated by a dishonest participant, a fraud can be detected. When a fraud is detected, the secure computation system 200 can stop its processing.

### [Secret Sharing Scheme]

The secure computation system 200 according to the second example embodiment can adopt a 2-out-of-4 replicated secret sharing scheme. Concretely, the shares of an element v on a residue class ring Z_{L} of modulo L on the residue class ring Z_{L} (v∈Z_{L}) are constituted as follows.

$${[ v ]}_{L} = ( {[ v ]}_{L , 0} , {[ v ]}_{L , 1} , {[ v ]}_{L , 2} , {[ v ]}_{L , 3} )$$

when mᵥ, λᵥ, λ_{v, 1}, λ_{v, 2}, λ_{v, 3}∈Z_{L},

$${m}_{v} = v + {λ}_{v} mod L$$

$${λ}_{v} = {λ}_{v , 1} + {λ}_{v , 2} + {λ}_{v , 3} mod L$$

In this case, the shares of the individual participants Pᵢ (i=0, 1, 2, 3) are defined as follows.

$$The share of the participant {P}_{0} {: [ v ]}_{L , 0} = ( {λ}_{v , 1} , {λ}_{v , 2} , {λ}_{v , 3} )$$

$$The share of the participant {P}_{1} {: [ v ]}_{L , 1} = ( {m}_{v} , {λ}_{v , 2} , {λ}_{v , 3} )$$

$$The share of the participant {P}_{2} {: [ v ]}_{L , 2} = ( {m}_{v} , {λ}_{v , 3} , {λ}_{v , 1} )$$

$$The share of the participant {P}_{3} {: [ v ]}_{L , 3} = ( {m}_{v} , {λ}_{v , 1} , {λ}_{v , 2} )$$

In the 2-out-of-4 replicated secret sharing scheme constructed as described above, it is possible to reconstruct the element v∈Z_{L} as follows.

$$v = {m}_{v} - {λ}_{v , 1} - {λ}_{v , 2} - {λ}_{v , 3}$$

The shares regarding a sequence V having a sequence length N (V=(λ₀, λ₁, . . . , λⱼ, . . . , λ_{N-1}) are constructed as follows.

$${m}_{vj} = {v}_{j} + {λ}_{vj} mod L$$

$${λ}_{vj} = {λ}_{vj , 1} + {λ}_{vj , 2} + {λ}_{vj , 3} mod L$$

$$M = ( {m}_{vj} , … , {m}_{vN - 1} )$$

$${Λ}_{1} = ( {λ}_{vj , 1} , … , {λ}_{vN - 1 , 1} )$$

$${Λ}_{2} = ( {λ}_{vj , 2} , … , {λ}_{vN - 1 , 2} )$$

$${Λ}_{3} = ( {λ}_{vj , 3} , … , {λ}_{vN - 1 , 3} )$$

### [Shuffle]

For example, a case in which a cyclic permutation for the zeroth participant P₀ is computed by using a cyclic permutation shared by the first to third participants Pᵢ (i=1, 2, 3) will be described. The cyclic permutation for the zeroth participant P₀ can be constituted as follows by using a cyclic permutation σ₀ shared by the first to third participants Pᵢ (i=1, 2, 3).

The first to third participants Pᵢ (i=1, 2, 3) apply the cyclic permutation σ₀ to the values of Λ₁, Λ₂, and Λ₃, mask the resultant values, and transmit the masked values to the zeroth participant P₀. In other words, the first to third participants Pᵢ (i=1, 2, 3) compute, for the zeroth participant P₀, the values of Λ₁, Λ₂, and Λ₃ to which the cyclic permutation σ₀ has been applied, and transmit these values to the zeroth participant P₀.

$$Senders \{ {P}_{1} , {P}_{2} \} : {α}_{3} + {σ}_{0} ( {Λ}_{3} )$$

$$Senders \{ {P}_{2} , {P}_{3} \} : {α}_{1} + {σ}_{0} ( {Λ}_{1} )$$

$$Senders \{ {P}_{1} , {P}_{3} \} : {α}_{2} + {σ}_{0} ( {Λ}_{2} )$$

Note that αᵢ=(α_{i, 0}, α_{i, 1}, . . . , α_{i, j}, . . . α_{i, N-1}) (i=1, 2, 3) is a mask that can be computed with a key and a pseudorandom function that only the sender knows, satisfying α_{0, j}+α_{1, j}+α_{2, j}+α_{3, j}=0 mod L (i=0, 1, . . . , N−1).

As seen from the above construction, the zeroth participant P₀ receives two same values (obtained by applying the cyclic permutation σ₀ to Λ₁, Λ₂, and Λ₃ and masking the resultant values). Next, the zeroth participant P₀ performs a fraud detection by performing an equality check on the plurality of values obtained after the application of the cyclic permutation.

Concretely, if the values, which are supposed to be the same value, are different from each other, the participant P₀ determines that there is a dishonest participant among the participants and this dishonest participant has falsified a value, and stops its processing. For example, the participant P₁ and the participant P₂ transmit the same value to the participant P₀. However, for example, the participant P₁ may transmit a hash value, instead of directly transmitting the value. In this case, the participant P₀ may convert the value received from the participant P₂ into a hash value and may perform an equality check between this hash value and the hash value received from the participant P₁. By transmitting a hash value in this way, the communication amount can be reduced.

The first to third participants Pᵢ (i=1, 2, 3) other than the zeroth participant P₀ can compute, by using the cyclic permutation σ₀ shared by the first to third participants Pᵢ (i=1, 2, 3) and the sub-shares held thereby, their shares to which the cyclic permutation σ₀ has been applied by themselves. The shares to which the cyclic permutation σ₀ has been applied can be finally constructed as follows.

$${P}_{0} {: [ {σ}_{0} ( V ) ]}_{L , 0} = ( {α}_{1} + {σ}_{0} ( {Λ}_{1} ) , {α}_{2} + {σ}_{0} ( {Λ}_{2} ) , {α}_{3} + {σ}_{0} ( {Λ}_{3} ) )$$

$${P}_{1} {: [ {σ}_{0} ( V ) ]}_{L , 1} = ( {α}_{0} + {σ}_{0} ( M ) , {α}_{2} + {σ}_{0} ( {Λ}_{2} ) , {α}_{3} + {σ}_{0} ( {Λ}_{3} ) )$$

$${P}_{2} {: [ {σ}_{0} ( V ) ]}_{L , 2} = ( {α}_{0} + {σ}_{0} ( M ) , {α}_{1} + {σ}_{0} ( {Λ}_{1} ) , {α}_{3} + {σ}_{0} ( {Λ}_{3} ) )$$

$${P}_{3} {: [ {σ}_{0} ( V ) ]}_{L , 3} = ( {α}_{0} + {σ}_{0} ( M ) , {α}_{1} + {σ}_{0} ( {Λ}_{1} ) , {α}_{2} + {σ}_{0} ( {Λ}_{2} ) )$$

The cyclic permutation σ₀ shared by the first to third participants Pᵢ (i=1, 2, 3) can be generated by using a key and a pseudorandom function shared by the first to third participants Pᵢ (i=1, 2, 3). That is, by using a pseudo random number generated by using a key and a pseudorandom function shared by the first to third participants Pᵢ (i=1, 2, 3) for a shift amount R₀ of the cyclic permutation Go, the cyclic permutation σ₀ shared by the first to third participant Pᵢ (i=1, 2, 3) can be constructed.

The cyclic permutation σ₀ can be featured by the shift amount R₀. A share [R₀]_{N} having the shift amount R₀ that features the cyclic permutation σ₀ can be constructed as follows.

$$The share of the participant {P}_{0} {: [ {R}_{0} ]}_{N , 0} = ( 0 , 0 , 0 )$$

$$The share of the participant {P}_{1} {: [ {R}_{0} ]}_{N , 1} = ( {R}_{0} , 0 , 0 )$$

$$The share of the participant {P}_{2} {: [ {R}_{0} ]}_{N , 2} = ( {R}_{0} , 0 , 0 )$$

$$The share of the participant {P}_{3} {: [ {R}_{0} ]}_{N , 3} = ( {R}_{0} , 0 , 0 )$$

Regarding the share [R₀]_{N} having the shift amount R₀ constructed as described above, although the participant P₀ cannot determine the shift amount R₀, the first to third participants Pᵢ (i=1, 2, 3) can determine the shift amount R₀. That is, the nature that the first to third participants Pᵢ (i=1, 2, 3) can trace the cyclic permutation although the zeroth participant P₀ cannot trace the cyclic permutation is maintained.

The cyclic permutation σ₀ constructed as described above is a cyclic permutation construction example in which the cyclic permutation σ₀ cannot be traced by the zeroth participant P₀ but can be traced by the first to third participants Pᵢ (i=1, 2, 3). The first to third participants Pᵢ (i=1, 2, 3) can alternately function in the same way as the zeroth participant P₀. As a result, it is possible to construct a cyclic permutation σᵢ (i=1, 2, 3) that cannot be traced by one of the first to third participants Pᵢ (i=1, 2, 3) but can be traced by the other participants.

Each of the cyclic permutations αᵢ (i=0, 1, 2, 3) constructed as described above is not traceable by one of the participants Pᵢ (i=0, 1, 2, 3). Thus, by synthesizing these cyclic permutations σᵢ (i=0, 1, 2, 3), it is possible to obtain σ=σ₀ σ₁ σ₂ σ₃ that can be traced by none of the participants Pᵢ (i=0, 1, 2, 3). That is, it is possible to construct a random cyclic permutation that can be traced by none of the participants Pᵢ (i=0, 1, 2, 3).

The fact that the shift amount of the random cyclic permutation σhaving the above nature can be computed by R₀+R₁+R₂+R₃ has already been described with reference to FIG. 3. If the reference target index is h, the index that needs to be referred to after the application of the random cyclic permutation is h′=h+R₀+R₁+R₂+R₃. In addition, although it is possible to compute the index h′ that needs to be referred to after the application of the random cyclic permutation a having the above nature, the original index h can be kept secret.

### (Secure Computation Method)

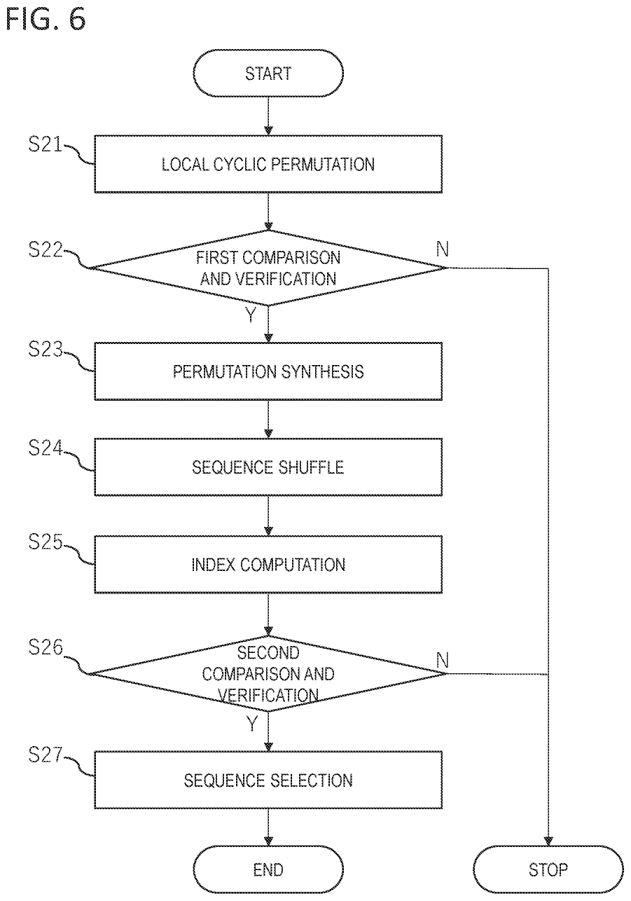

FIG. 6 is a flowchart illustrating an outline of a procedure of a secure computation method according to the second example embodiment. The procedure of the secure computation method illustrated in FIG. 6 is only a typical example of the procedure of the secure computation and will be described to facilitate the description. In practice, the secure computation method can be modified, such as by changing the order of some of the steps or repeating some of the steps.

As illustrated in FIG. 6, the secure computation method according to the second example embodiment includes a local cyclic permutation step (step S21), a first comparison and verification step (step S22), a permutation synthesis step (step S23), a sequence shuffle step (step S24), an index computation step (step S25), a second comparison and verification step (step S26), and a sequence selection step (step S27).

The local cyclic permutation step (step S21) includes computing, by using a cyclic permutation shared by three of the zeroth to third secure computation server apparatuses 210ᵢ (i=0, 1, 2, 3), a value of a cyclic permutation for the other secure computation server apparatus.

The first comparison and verification step (step S22) includes performing a fraud detection by performing an equality check on a plurality of values of cyclic permutations computed by the zeroth to third secure computation server apparatuses 210ᵢ (i=0, 1, 2, 3) except one of the secure computation server apparatuses. Concretely, if the plurality of received values of the cyclic permutations are the same value (step S22; Y), the processing is continued. If the plurality of received values of the cyclic permutations are different values (step S22; N), it is determined that a dishonest participant among the participants has falsified a value, and the processing is stopped.

The permutation synthesis step (step S23) includes constituting a random cyclic permutation that is traceable by none of the zeroth to third secure computation server apparatuses 210ᵢ (i=0, 1, 2, 3) by synthesizing the cyclic permutations of the zeroth to third secure computation server apparatuses 210ᵢ (i=0, 1, 2, 3) constituted in the local cyclic permutation step (step S21).

The sequence shuffle step (step S24) includes applying the random cyclic permutation to the shares in the reference target sequence.

The index computation step (step S25) includes computing a share which indicates index and to which the random cyclic permutation has been applied by adding a share having shift amounts of the cyclic permutation constituted by the local cyclic permutation parts to the received share which indicates the index. This computation principle has already been described above.

The second comparison and verification step (step S26) includes receiving, when the share which indicates the index and to which the random cyclic permutation has been applied are reconstructed, shares not held by one secure computation server apparatus from the other secure computation server apparatuses and performing a fraud detection by performing an equality check on a plurality of shares which indicate indexes. The computations of the share which indicates the index and to which the random cyclic permutation has been applied in the index computation step (step S25) are performed as secure computations. Thus, when the share which indicates the index is reconstructed, the shares not held by one secure computation server apparatus are received from the other secure computation server apparatuses. That is, in this step, there is a possibility that a value could be falsified by a dishonest person who has slipped into the group of participants. Thus, in the second comparison and verification step (step S26), a fraud detection is performed by performing an equality check on the plurality of received shares which indicate indexes. Concretely, if the plurality of received values of the cyclic permutations are the same value (step S26; Y), the processing is continued. If the plurality of received values of the cyclic permutations are different values (step S26; N), it is determined that a dishonest participant among the participants has falsified a value, and the processing is stopped.

The sequence selection step (step S27) includes selecting, by using the reconstructed indexes obtained after the random cyclic permutation has been applied, a share corresponding to the reconstructed index from the shares in the sequence to which the random cyclic permutation has been applied.

As described above, the secure computation system and the secure computation method according to the second example embodiment enable a fraud detection while using a sequence reference protocol that achieves the communication cost with a constant number of rounds. If a falsification has been made, the processing can be stopped. That is, the secure computation system and the secure computation method according to the second example embodiment contribute to both reducing the communication cost and improving the security while using a sequence reference protocol.

### Third Example Embodiment

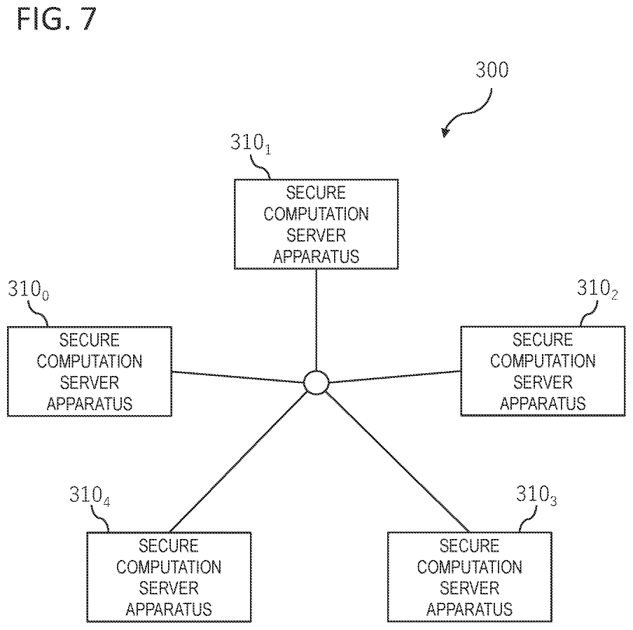

Next, a secure computation system according to a third example embodiment will be described with reference to FIG. 7.

FIG. 7 is a block diagram illustrating a functional configuration example of the secure computation system according to the third example embodiment. As illustrated in FIG. 7, a secure computation system 300 according to the third example embodiment includes zeroth to fourth secure computation server apparatuses 310ᵢ (i=0, 1, 2, 3, 4). The zeroth to fourth secure computation server apparatuses 310ᵢ (i=0, 1, 2, 3, 4) are connected to each other via a network such that these apparatuses can communicate with each other.

The secure computation system 300 according to the third example embodiment illustrated in FIG. 7 is a secure computation system that receives a share which indicates index, and that refers to a share of an element in a sequence corresponding to the index from the shares in the sequence. Each of the zeroth to fourth secure computation server apparatuses 310ᵢ (i=0, 1, 2, 3, 4) is operated by an independent participant Pᵢ (i=0, 1, 2, 3, 4). In addition, in the secure computation system 300 including the zeroth to fourth secure computation server apparatuses 310ᵢ (i=0, 1, 2, 3, 4), even if part of the zeroth to fourth secure computation server apparatuses 310ᵢ (i=0, 1, 2, 3, 4) is operated by a dishonest participant, a fraud can be detected. When a fraud is detected, the secure computation system 300 can stop its processing.

### [Secret Sharing Scheme]

The secure computation system 300 according to the third example embodiment can adopt a 2-out-of-5 replicated secret sharing scheme. Concretely, the shares of an element v on a residue class ring Z_{L} of modulo L on the residue class ring Z_{L} (v∈Z_{L}) are constituted as follows.

$${[ v ]}_{L} = ( {[ v ]}_{L , 0} , {[ v ]}_{L , 1} , {[ v ]}_{L , 2} , {[ v ]}_{L , 3} , {[ v ]}_{L , 4} )$$

where v=v₀+v₁+v₂+v₃+v₄ mod L

The share of the participant Pᵢ is defined as [v]_{L, i}=(vᵢ, vᵢ₊₁, vᵢ₊₁, vᵢ₊₃). Note that x₄₊₁=x₀.

The shares regarding a sequence V having a sequence length N (V=(v₀, v₁, . . . , vⱼ, . . . , v_{N-1}) are constructed as Vᵢ=(v_{0, i}, . . . , v_{N-1, i}) (i=0, 1, 2, 3, 4) where vⱼ=v_{j, 0}+v_{j, 1}+v_{j, 2}+v_{j, 3}+v_{j, 4} mod L.

### [Shuffle]

For example, a case in which a cyclic permutation for the zeroth participant P₀ is computed by using a cyclic permutation shared by the first to fourth participants Pᵢ (i=1, 2, 3, 4) will be described. The cyclic permutation for the zeroth participant P₀ can be constituted as follows by using a cyclic permutation Go shared by the first to fourth participants Pᵢ (i=1, 2, 3, 4).

The first to fourth participants Pᵢ (i=1, 2, 3, 4) apply the cyclic permutation σ₀ to the values of Vᵢ (Vᵢ=(v_{0, i}, . . . , v_{N-1, i}) (i=0, 1, 2, 3, 4)), mask the resultant values, and transmit the masked values to the zeroth participant P₀. In other words, the first to fourth participants Pᵢ (i=1, 2, 3, 4) compute, for the zeroth participant P₀, the values of v₁ (i=0, 1, 2, 3, 4) to which the cyclic permutation σ₀ has been applied, and transmit these values to the zeroth participant P₀.

Senders {P₂,P₃,P₄}:α₀+σ₀(V₀)

Senders {P₁,P₃,P₄}:α₁+σ₀(V₁)

Senders {P₁,P₂,P₄}:α₂+σ₀(V₂)

Senders {P₁,P₂,P₃}:α₃+σ₀(V₃)

Note that αᵢ=(α_{i, 0}, α_{i, 1} . . . α_{i, j}m . . . , α_{i, N-1}) (i=1, 2, 3, 4) is a mask that can be computed with a key and a pseudorandom function that only the sender knows, satisfying α_{0, j}+α_{i, j}+α_{2, j}+α_{3, j}=0 mod L (i=0, 1, . . . , N−1).

As seen from the above construction, the zeroth participant P₀ receives three same values (obtained by applying the cyclic permutation σ₀ to Vᵢ (i=0, 1, 2, 3, 4) and masking the resultant values). Next, the zeroth participant P₀ selects, from the plurality of values of the cyclic permutations, a majority of values determined to be the same value, and continues its processing. That is, even if a falsification has been made, the zeroth participant P₀ can select an accurate value and continue its processing.

Concretely, the participant P₀ selects at least two of the three received values, the two values having been determined to be the same value, as an accurate value. That is, even if a falsification has been made, since two of the three received values are the same value, the participant P₀ can select an accurate value. For example, while the participant P₁, the participant P₂, and the participant P₃ transmit the same value to the participant P₀, for example, the participant P₁ and the participant P₂ may transmit a hash value, instead of directly transmitting the value. In this case, the participant P₀ may convert the value received from the participant P₃ into a hash value, and perform an equality check between this hash value and the hash values received from the participant P₁ and the participant P₂. By transmitting hash values in this way, the communication amount can be reduced.

The first to fourth participants Pᵢ (i=1, 2, 3, 4) other than the zeroth participant P₀ can compute, by using the cyclic permutation σ₀ shared by the first to fourth participants Pᵢ (i=1, 2, 3, 4) and the sub-shares held thereby, their shares to which the cyclic permutation σ₀ has been applied by themselves. The shares to which the cyclic permutation σ₀ has been applied can be finally constructed as follows.

$${P}_{i} {: [ {σ}_{0} ( V ) ]}_{L , i} = ( {α}_{i} + {σ}_{0} ( {V}_{i} ) , {α}_{i + 1} + {σ}_{0} ( {V}_{i + 1} ) , {α}_{i + 1} + {σ}_{0} ( {V}_{i + 2} ) , {α}_{i + 3} + {σ}_{0} ( {V}_{i + 3} ) )$$

The cyclic permutation σ₀ shared by the first to fourth participants Pᵢ (i=1, 2, 3, 4) can be generated by using a key and a pseudorandom function shared by the first to fourth participants Pᵢ (i=1, 2, 3, 4). That is, by using a pseudo random number generated by using a key and a pseudorandom function shared by the first to fourth participants Pᵢ (i=1, 2, 3, 4) for a shift amount R₀ of the cyclic permutation σ₀, the cyclic permutation σ₀ shared by the first to fourth participants Pᵢ (i=1, 2, 3, 4) can be constructed.

The cyclic permutation σ₀ constructed as described above is a cyclic permutation construction example in which the cyclic permutation σ₀ cannot be traced by the zeroth participant P₀ but can be traced by the first to fourth participants Pᵢ (i=1, 2, 3, 4). The first to fourth participant Pᵢ (i=1, 2, 3, 4) can alternately function in the same way as the zeroth participant P₀. As a result, it is possible to construct a cyclic permutation σᵢ (i=1, 2, 3, 4) that cannot be traced by one of the first to fourth participants Pᵢ (i=1, 2, 3, 4) but can be traced by the other participants.

Each of the cyclic permutations σᵢ (i=0, 1, 2, 3, 4) constructed as described above is not traceable by one of the participants Pᵢ (i=0, 1, 2, 3, 4). Thus, by synthesizing these cyclic permutations σᵢ (i=0, 1, 2, 3, 4), it is possible to obtain σ=σ₀ σ₁ σ₂ σ₃ σ₄ that can be traced by none of the participants Pᵢ (i=0, 1, 2, 3, 4). That is, it is possible to construct a random cyclic permutation that can be traced by none of the participants Pᵢ (i=0, 1, 2, 3, 4).

The fact that the shift amount of the random cyclic permutation a having the above nature can be computed by R₀+R₁+R₂+R₃+R₄ has already been described with reference to FIG. 3. If the reference target index is h, the index that needs to be referred to after the application of the random cyclic permutation is h′=h+R₀+R₁+R₂+R₃+R₄. In addition, although it is possible to compute the index h′ that needs to be referred to after the application of the random cyclic permutation a having the above nature, the original index h can be kept secret.

### (Secure Computation Method)

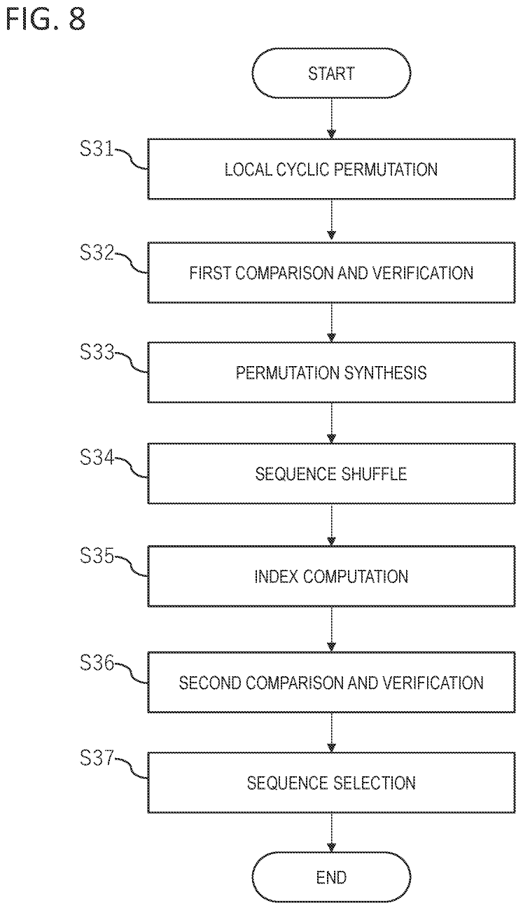

FIG. 8 is a flowchart illustrating an outline of a procedure of a secure computation method according to the third example embodiment. The procedure of the secure computation method illustrated in FIG. 8 is only a typical example of the procedure of the secure computation and will be described to facilitate the description. In practice, the secure computation method can be modified, such as by changing the order of some of the steps or repeating some of the steps.

As illustrated in FIG. 8, the secure computation method according to the third example embodiment includes a local cyclic permutation step (step S31), a first comparison and verification step (step S32), a permutation synthesis step (step S33), a sequence shuffle step (step S34), an index computation step (step S35), a second comparison and verification step (step S36), and a sequence selection step (step S37).

The local cyclic permutation step (step S31) includes computing, by using a cyclic permutation shared by four of the zeroth to fourth secure computation server apparatuses 310ᵢ (i=0, 1, 2, 3, 4), a value of a cyclic permutation for the other secure computation server apparatus.

The first comparison and verification step (step S32) includes performing a fraud detection by performing an equality check on a plurality of values of cyclic permutations computed by the zeroth to fourth secure computation server apparatuses 310ᵢ (i=0, 1, 2, 3, 4) except one of the secure computation server apparatuses. Concretely, the first comparison and verification step (step S32) includes selecting at least two of the three received values, the two values having been determined to be the same value, as an accurate value, and continuing the processing by selecting the accurate value even if a falsification has been made.

The permutation synthesis step (step S33) includes constituting a random cyclic permutation that is traceable by none of the zeroth to fourth secure computation server apparatuses 310ᵢ (i=0, 1, 2, 3, 4) by synthesizing the cyclic permutations constituted in the local cyclic permutation step (step S31).

The sequence shuffle step (step S34) includes applying the random cyclic permutation to the shares in the reference target sequence.

The index computation step (step S35) includes computing a share which indicates index and to which the random cyclic permutation has been applied by adding a share having a shift amount of the cyclic permutation constituted by the local cyclic permutation parts to the received share which indicates the index. This computation principle has already been described above.

The second comparison and verification step (step S36) includes receiving, when the share which indicates the index and to which the random cyclic permutation has been applied are reconstructed, shares not held by one secure computation server apparatus from the other secure computation server apparatuses and performing a fraud detection by performing an equality check on a plurality of shares which indicate indexes. The computations of the share which indicates the index and to which the random cyclic permutation has been applied in the index computation step (step S35) are performed as secure computations. Thus, when the shares which indicate the indexes are reconstructed, the share not held by one secure computation server apparatus is received from the other secure computation server apparatuses. That is, in this step, there is a possibility that a value could be falsified by a dishonest person who has slipped into the group of participants. Thus, in the second comparison and verification step (step S36), a fraud detection is performed by performing an equality check on the plurality of received shares which indicate indexes. Concretely, at least two of the three received values, the two values having been determined to be the same value, are selected as an accurate value. Even if a falsification has been made, an accurate value is selected and the processing is continued.

The sequence selection step (step S37) includes selecting, by using the reconstructed index obtained after the random cyclic permutation has been applied, a share corresponding to the reconstructed index from the shares in the sequence to which the random cyclic permutation has been applied.

As described above, the secure computation system and the secure computation method according to the third example embodiment enable a fraud detection while using a sequence reference protocol that achieves the communication cost with a constant number of rounds. Even if a falsification has been made, the processing can be continued by selecting an accurate value. That is, the secure computation system and the secure computation method according to the third example embodiment contribute to both reducing the communication cost and improving the security while using a sequence reference protocol.

### [Hardware Configuration Example]

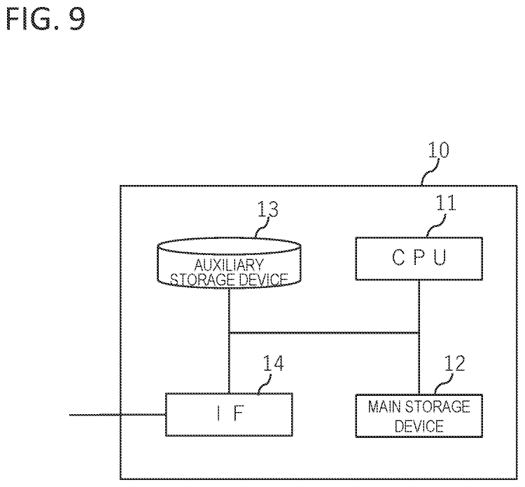

FIG. 9 is a diagram illustrating a hardware configuration example of a secure computation server apparatus. That is, the hardware configuration example illustrated in FIG. 9 is a hardware configuration example of any one of the secure computation server apparatuses 110ᵢ, 210ᵢ, and 310ᵢ. An information processing apparatus (a computer) that adopts the hardware configuration illustrated in FIG. 9 can realize the individual functions of any one of the secure computation server apparatuses 110ᵢ, 210ᵢ, and 310ᵢ by executing the corresponding one of the above secure computation methods as a program.

The hardware configuration example illustrated in FIG. 9 is an example of the hardware configuration that realizes the individual functions of any one of the secure computation server apparatuses 110ᵢ, 210ᵢ, and 3101 and does not limit the hardware configuration of any one of the secure computation server apparatuses 110ᵢ, 210ᵢ, and 310ᵢ. The secure computation server apparatuses 110ᵢ, 210ᵢ, and 310ᵢ may include hardware not illustrated in FIG. 9.

As illustrated in FIG. 9, a hardware configuration 10 that can be adopted by any one of the secure computation server apparatuses 110ᵢ, 210ᵢ, and 3101 includes, for example, a CPU (Central Processing Unit) 11, a main storage device 12, an auxiliary storage device 13, and an IF (Interface) part 14, which are connected to each other via an internal bus.

The CPU 11 executes various commands included in the secure computation program executed by the corresponding one of the secure computation server apparatuses 110ᵢ, 210ᵢ, and 310ᵢ. The main storage device 12 is, for example, a RAM (Random Access Memory) and temporarily stores various kinds of programs such as the secure computation program executed by the corresponding one of the secure computation server apparatuses 110ᵢ, 210ᵢ, and 310ᵢ so that the CPU 11 can execute the programs.

The auxiliary storage device 13 is, for example, an HDD (Hard Disk Drive) and can store, in the mid-to-long term, various kinds of programs such as the secure computation program executed by the corresponding one of the secure computation server apparatuses 110ᵢ, 210ᵢ, and 310ᵢ. These various kinds of programs such as the secure computation program can be recorded in a non-transitory computer-readable storage medium and can be provided as a program product. The auxiliary storage device 13 can be used to store, in the mid-to-long term, various kinds of programs such as the secure computation program recorded in a non-transitory computer-readable storage medium. The IF part 14 provides an interface regarding the input and output among the corresponding secure computation server apparatuses 110ᵢ, 210ᵢ, or 310ᵢ.

An information processing apparatus that adopts the hardware configuration 10 as described above realizes the functions of any one of the secure computation server apparatuses 110ᵢ, 210ᵢ, and 310ᵢ by executing the corresponding one of the above-described secure computation methods as a program.

The above example embodiments can partially or entirely be described, but not limited to, as the following notes.

### [Note 1]

A secure computation system, including at least four secure computation server apparatuses connected to each other via a network, receiving a share which indicates index, and referring to a share of an element in a sequence corresponding to the index from the shares in the sequence, an individual one of the secure computation server apparatuses including:
a local cyclic permutation part that computes, by using a cyclic permutation shared by (other) secure computation server apparatuses except one of the at least four secure computation server apparatuses, a value of a cyclic permutation for the one secure computation server apparatus;
a comparison and verification part that performs a fraud detection by performing an equality check on a plurality of values of cyclic permutations computed by the secure computation server apparatuses except oneself of the at least four secure computation server apparatuses;
a permutation synthesis part that constitutes a random cyclic permutation that is traceable by none of the at least four secure computation server apparatuses by synthesizing the cyclic permutations constituted by the local cyclic permutation parts of the secure computation server apparatuses;
a sequence shuffle part that applies the random cyclic permutation to the shares in the sequence;
an index computation part that computes a share which indicates index and to which the random cyclic permutation has been applied by adding a share having a shift amount of the cyclic permutation constituted by the local cyclic permutation parts to the received share which indicates the index; and
a sequence selection part that reconstructs the share which indicates the index and to which the random cyclic permutation has been applied and that selects a share corresponding to the reconstructed index from the shares in the sequence to which the random cyclic permutation has been applied.

### [Note 2]

The secure computation system according to note 1; wherein the individual one of the secure computation server apparatuses includes a second comparison and verification part that receives, when the shares which indicate indexes and to which the random cyclic permutation has been applied are reconstructed, shares not held by own secure computation server apparatus from the other secure computation server apparatuses and that performs a fraud detection by performing an equality check on the plurality of received shares which indicate the indexes.

### [Note 3]

The secure computation system according to note 1 or 2; wherein the cyclic permutation shared by (other) secure computation server apparatuses except one of the at least four secure computation server apparatuses is generated by using a key and a pseudorandom function shared by the secure computation server apparatuses except one of the at least four secure computation server apparatuses.

### [Note 4]

The secure computation system according to note 3; wherein the shift amount of the cyclic permutation is generated by using a key and a pseudorandom function shared by the secure computation server apparatuses except one of the at least four secure computation server apparatuses.

### [Note 5]

The secure computation system according to any one of notes 1 to 4; wherein the secure computation system is based on a 2-out-of-4 replicated secret sharing scheme including four of the secure computation server apparatuses and stops processing of the secure computation system when a fraud is detected by the equality check.

### [Note 6]

The secure computation system according to any one of notes 1 to 4; wherein the secure computation system is based on a 2-out-of-5 replicated secret sharing scheme including five of the secure computation server apparatuses, selects a majority of values determined to be the same value by the equality check, and continues processing of the secure computation system.

### [Note 7]

A secure computation server apparatus, which is one of at least four secure computation server apparatuses connected to each other via a network, each of the secure computation server apparatuses receiving a share which indicates an index, and referring to a share of an element in a sequence corresponding to the index from the shares in the sequence, the secure computation server apparatus including:
a local cyclic permutation part that computes, by using a cyclic permutation shared by (other) secure computation server apparatuses except one of the at least four secure computation server apparatuses, a value of a cyclic permutation for the one secure computation server apparatus;
a comparison and verification part that performs a fraud detection by performing an equality check on a plurality of values of cyclic permutations computed by the secure computation server apparatuses except oneself of the at least four secure computation server apparatuses;
a permutation synthesis part that constitutes a random cyclic permutation that is traceable by none of the at least four secure computation server apparatuses by synthesizing the cyclic permutations constituted by the local cyclic permutation parts of the secure computation server apparatuses;
a sequence shuffle part that applies the random cyclic permutation to the shares in the sequence;
an index computation part that computes a share which indicates an index and to which the random cyclic permutation has been applied by adding a share having a shift amount of the cyclic permutation constituted by the local cyclic permutation parts to the received shares which indicates the index; and
a sequence selection part that reconstructs the share which indicates the index and to which the random cyclic permutation has been applied and that selects a share corresponding to the reconstructed index from the shares in the sequence to which the random cyclic permutation has been applied.

### [Note 8]

A secure computation method, using at least four secure computation server apparatuses connected to each other via a network, receiving a share which indicates an index, and referring to a share of an element in a sequence corresponding to the index from the shares in the sequence, the secure computation method comprising:
a local cyclic permutation step of computing, by using a cyclic permutation shared by (other) secure computation server apparatuses except one of the at least four secure computation server apparatuses, a value of a cyclic permutation for the one secure computation server apparatus;
a comparison and verification step of performing a fraud detection by performing an equality check on a plurality of values of cyclic permutations computed by the secure computation server apparatuses except oneself of the at least four secure computation server apparatuses;
a permutation synthesis step of constituting a random cyclic permutation that is traceable by none of the at least four secure computation server apparatuses by synthesizing the cyclic permutations constituted in the local cyclic permutation step;
a sequence shuffle step of applying the random cyclic permutation to the shares in the sequence;
an index computation step of computing a share which indicates an index and to which the random cyclic permutation has been applied by adding a share having a shift amount of the cyclic permutation constituted by the local cyclic permutation step to the received share which indicates the index; and
a sequence selection step of reconstructing the share which indicates the index and to which the random cyclic permutation has been applied and selecting a share corresponding to the reconstructed index from the shares in the sequence to which the random cyclic permutation has been applied.

### [Note 9]

The secure computation method according to note 8; wherein the local cyclic permutation step, the comparison and verification step, the permutation synthesis step, and the sequence shuffle step are performed before the share which indicates the index is received.

### [Note 10]

A secure computation program, causing each of at least four secure computation server apparatuses connected to each other via a network, each of the secure computation server apparatuses receiving a share which indicates an index, and referring to a share of an element in a sequence corresponding to the index from the shares in the sequence, to perform:
local cyclic permutation processing for computing, by using a cyclic permutation shared by the secure computation server apparatuses except one of the at least four secure computation server apparatuses, a value of a cyclic permutation for the one secure computation server apparatus;
comparison and verification processing for performing a fraud detection by performing an equality check on a plurality of values of cyclic permutations computed by the secure computation server apparatuses except oneself of the at least four secure computation server apparatuses;
permutation synthesis processing for constituting a random cyclic permutation that is traceable by none of the at least four secure computation server apparatuses by synthesizing the cyclic permutations constituted by the local cyclic permutation processing;
sequence shuffle processing for applying the random cyclic permutation to the shares in the sequence;
index computation processing for computing a share which indicates an index and to which the random cyclic permutation has been applied by adding a share having a shift amount of the cyclic permutation constituted by the local cyclic permutation processing to the received share which indicates the index; and
sequence selection processing for reconstructing the shares which indicates the index and to which the random cyclic permutation has been applied and selecting a share corresponding to the reconstructed index from the shares in the sequence to which the random cyclic permutation has been applied.

The disclosure of the above NPL is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed. In addition, as needed and based on the gist of the present invention, partial or entire use of the individual disclosed matters in the above literatures that have been referred to in combination with what is disclosed in the present application should be deemed to be included in what is disclosed in the present application, as a part of the disclosure of the present invention.

### REFERENCE SIGNS LIST

0, 200, 300 secure computation system
110ᵢ, 210ᵢ, 310ᵢ secure computation server apparatus
111 local cyclic permutation part
112 comparison and verification part
113 permutation synthesis part
114 sequence shuffle part
115 index computation part
116 sequence selection part
10 hardware configuration
11 CPU (Central Processing Unit)
12 main storage device
13 auxiliary storage device
14 IF (Interface) part

What is claimed is:

1. A secure computation system, comprising at least four secure computation server apparatuses connected to each other via a network, receiving a share which indicates an index, and referring to a share of an element in a sequence corresponding to the index from the shares in the sequence, an individual one of the secure computation server apparatuses including:
a local cyclic permutation part that computes, by using a cyclic permutation shared by secure computation server apparatuses except one of the at least four secure computation server apparatuses, a value of a cyclic permutation for the one secure computation server apparatus;
a comparison and verification part that performs a fraud detection by performing an equality check on a plurality of values of cyclic permutations computed by the secure computation server apparatuses except oneself of the at least four secure computation server apparatuses;
a permutation synthesis part that constitutes a random cyclic permutation that is traceable by none of the at least four secure computation server apparatuses by synthesizing the cyclic permutations constituted by the local cyclic permutation parts of the secure computation server apparatuses;
a sequence shuffle part that applies the random cyclic permutation to the shares in the sequence;
an index computation part that computes a share which indicates an index and to which the random cyclic permutation has been applied by adding a share having a shift amount of the cyclic permutation constituted by the local cyclic permutation parts to the received share which indicates the index; and
a sequence selection part that reconstructs the share which indicates the index and to which the random cyclic permutation has been applied and that selects a share corresponding to the reconstructed index from the shares in the sequence to which the random cyclic permutation has been applied.

2. The secure computation system according to claim 1; wherein the individual one of the secure computation server apparatuses comprises a second comparison and verification part that receives, when the shares which indicate indexes and to which the random cyclic permutation has been applied are reconstructed, shares not held by own secure computation server apparatus from the other secure computation server apparatuses and that performs a fraud detection by performing an equality check on the plurality of received shares which indicate the indexes.

3. The secure computation system according to claim 1; wherein the cyclic permutation shared by the secure computation server apparatuses except one of the at least four secure computation server apparatuses is generated by using a key and a pseudorandom function shared by the secure computation server apparatuses except one of the at least four secure computation server apparatuses.

4. The secure computation system according to claim 3; wherein the shift amount of the cyclic permutation is generated by using a key and a pseudorandom function shared by the secure computation server apparatuses except one of the at least four secure computation server apparatuses.

5. The secure computation system according to claim 1; wherein the secure computation system is based on a 2-out-of-4 replicated secret sharing scheme including four of the secure computation server apparatuses and stops processing of the secure computation system when a fraud is detected by the equality check.

6. The secure computation system according to claim 1; wherein the secure computation system is based on a 2-out-of-5 replicated secret sharing scheme including five of the secure computation server apparatuses, selects a majority of values determined to be a same value by the equality check, and continues processing of the secure computation system.

7. A secure computation server apparatus, which is one of at least four secure computation server apparatuses connected to each other via a network, each of the secure computation server apparatuses receiving a share which indicates an index, and referring to a share of an element in a sequence corresponding to the index from the shares in the sequence, the secure computation server apparatus comprising:
a local cyclic permutation part that computes, by using a cyclic permutation shared by secure computation server apparatuses except one of the at least four secure computation server apparatuses, a value of a cyclic permutation for the one secure computation server apparatus;
a comparison and verification part that performs a fraud detection by performing an equality check on a plurality of values of cyclic permutations computed by the secure computation server apparatuses except oneself of the at least four secure computation server apparatuses;
a permutation synthesis part that constitutes a random cyclic permutation that is traceable by none of the at least four secure computation server apparatuses by synthesizing the cyclic permutations constituted by the local cyclic permutation parts of the secure computation server apparatuses;
a sequence shuffle part that applies the random cyclic permutation to the shares in the sequence;
an index computation part that computes a share which indicates an index and to which the random cyclic permutation has been applied by adding a share having a shift amount of the cyclic permutation constituted by the local cyclic permutation parts to the received share which indicates the index; and
a sequence selection part that reconstructs the share which indicates the index and to which the random cyclic permutation has been applied and that selects a share corresponding to the reconstructed index from the shares in the sequence to which the random cyclic permutation has been applied.

8. A secure computation method, using at least four secure computation server apparatuses connected to each other via a network, receiving a share which indicates an index, and referring to a share of an element in a sequence corresponding to the index from the shares in the sequence, the secure computation method comprising:
a local cyclic permutation step of computing, by using a cyclic permutation shared by secure computation server apparatuses except one of the at least four secure computation server apparatuses, a value of a cyclic permutation for the one secure computation server apparatus;
a comparison and verification step of performing a fraud detection by performing an equality check on a plurality of values of cyclic permutations computed by the secure computation server apparatuses except oneself of the at least four secure computation server apparatuses;
a permutation synthesis step of constituting a random cyclic permutation that is traceable by none of the at least four secure computation server apparatuses by synthesizing the cyclic permutations constituted in the local cyclic permutation step;
a sequence shuffle step of applying the random cyclic permutation to the shares in the sequence;
an index computation step of computing a share which indicates an index and to which the random cyclic permutation has been applied by adding a share having a shift amount of the cyclic permutation constituted by the local cyclic permutation step to the received share which indicates the index; and
a sequence selection step of reconstructing the share which indicates the index and to which the random cyclic permutation has been applied and selecting a share corresponding to the reconstructed index from the shares in the sequence to which the random cyclic permutation has been applied.

9. The secure computation method according to claim 8; wherein the local cyclic permutation step, the comparison and verification step, the permutation synthesis step, and the sequence shuffle step are performed before the share which indicates the index is received.

10. A non-transient computer readable medium storing secure computation program, causing each of at least four secure computation server apparatuses connected to each other via a network, each of the secure computation server apparatuses receiving a share which indicates an index, and referring to a share of an element in a sequence corresponding to the index from the shares in the sequence, to perform:
local cyclic permutation processing for computing, by using a cyclic permutation shared by secure computation server apparatuses except one of the at least four secure computation server apparatuses, a value of a cyclic permutation for the one secure computation server apparatus;
comparison and verification processing for performing a fraud detection by performing an equality check on a plurality of values of cyclic permutations computed by the secure computation server apparatuses except oneself of the at least four secure computation server apparatuses;
permutation synthesis processing for constituting a random cyclic permutation that is traceable by none of the at least four secure computation server apparatuses by synthesizing the cyclic permutations constituted by the local cyclic permutation processing;
sequence shuffle processing for applying the random cyclic permutation to the shares in the sequence;
index computation processing for computing a share which indicates an index and to which the random cyclic permutation has been applied by adding a share having a shift amount of the cyclic permutation constituted by the local cyclic permutation processing to the received share which indicates the index; and
sequence selection processing for reconstructing the share which indicates the index and to which the random cyclic permutation has been applied and selecting a share corresponding to the reconstructed index from the shares in the sequence to which the random cyclic permutation has been applied.

11. The secure computation server apparatus according to claim 7; wherein the individual one of the secure computation server apparatuses comprises a second comparison and verification part that receives, when the shares which indicate indexes and to which the random cyclic permutation has been applied are reconstructed, shares not held by own secure computation server apparatus from the other secure computation server apparatuses and that performs a fraud detection by performing an equality check on the plurality of received shares which indicate the indexes.

12. The secure computation server apparatus according to claim 7; wherein the cyclic permutation shared by the secure computation server apparatuses except one of the at least four secure computation server apparatuses is generated by using a key and a pseudorandom function shared by the secure computation server apparatuses except one of the at least four secure computation server apparatuses.

13. The secure computation server apparatus according to claim 12; wherein the shift amount of the cyclic permutation is generated by using a key and a pseudorandom function shared by the secure computation server apparatuses except one of the at least four secure computation server apparatuses.

14. The secure computation server apparatus according to claim 7; wherein the secure computation server apparatus is based on a 2-out-of-4 replicated secret sharing scheme including four of the secure computation server apparatuses and stops processing of the secure computation server apparatus when a fraud is detected by the equality check.

15. The secure computation server apparatus according to claim 7; wherein the secure computation server apparatus is based on a 2-out-of-5 replicated secret sharing scheme including five of the secure computation server apparatuses, selects a majority of values determined to be a same value by the equality check, and continues processing of the secure computation server apparatus.

16. The secure computation method according to claim 8; wherein the secure computation method comprises a second comparison and verification step of receiving, when the shares which indicate indexes and to which the random cyclic permutation has been applied are reconstructed, shares not held by own secure computation server apparatus from the other secure computation server apparatuses and that performs a fraud detection by performing an equality check on the plurality of received shares which indicate the indexes.

17. The secure computation method according to claim 8; wherein the cyclic permutation shared by the secure computation server apparatuses except one of the at least four secure computation server apparatuses is generated by using a key and a pseudorandom function shared by the secure computation server apparatuses except one of the at least four secure computation server apparatuses.

18. The secure computation method according to claim 17; wherein the shift amount of the cyclic permutation is generated by using a key and a pseudorandom function shared by the secure computation server apparatuses except one of the at least four secure computation server apparatuses.

19. The secure computation method according to claim 8; wherein the secure computation method is based on a 2-out-of-4 replicated secret sharing scheme including four of the secure computation server apparatuses and stops processing of the secure computation method when a fraud is detected by the equality check.

20. The secure computation method according to claim 8; wherein the secure computation method is based on a 2-out-of-5 replicated secret sharing scheme including five of the secure computation server apparatuses, selects a majority of values determined to be a same value by the equality check, and continues processing of the secure computation method.
